(19) United States
(12) Patent Application Publication
(10) Pub. No.: US 2019/0164183 A1
(43) Pub. Date: May 30, 2019

(54) COMPARABLE-BASED PRICING FOR NON-IDENTICAL INVENTORY

(71) Applicant: BROKER GENIUS, LLC, FAR ROCKAWAY, NY (US)

(72) Inventors: Shmuel Sherman, Valley Stream, NY (US); Jim McGowan, Flemington, NJ (US)

(21) Appl. No.: 16/206,275

(22) Filed: Nov. 30, 2018

Related U.S. Application Data
(60) Provisional application No. 62/593,024, filed on Nov. 30, 2017.

(51) Int. Cl. G06Q 30/02; G06Q 10/08

(52) U.S. Cl. CPC G06Q 30/0206; G06Q 30/0201; G06Q 10/087

(57) ABSTRACT

A method is provided for updating the price of an item, where a reference to the price is stored in an electronic database, the method comprising using at least one processor configured with code executing therein, a memory for storing the code and a communication to at least one database of references to inventory available for sale, wherein the processor is configured implement the steps of generating a filtering protocol using one or more pre-set pricing criteria, storing the filtering protocol in a database and retrieving pricing data for comparable inventory from an inventory exchange server. Additionally, a step filtering the retrieved pricing data using the filtering protocol and calculating a price for inventory based on the filtered dataset is performed by a suitably configured processor. A step of updating the price reference reflect the newly calculated price is also performed.

### RELATED APPLICATIONS

Cross Reference this application claims priority to U.S. Application No. 62/593,024, filed on Nov. 30, 2017 and incorporates the contents thereof by reference as if provided in its entirety.

### BACKGROUND OF THE INVENTION

The following co-pending applications are herein incorporated by reference in their respective entireties: U.S. Non-Provisional patent application Ser. No. 16/031,955, titled: VARIOUS METHODS FOR DISPLAYING VENUE INFORMATION ON A VENUE MAP and filed: Jul. 10, 2018; U.S. Non-Provisional patent application Ser. No. 16/031,907, titled AUTOMATED COMPARABLE-BASED PRICING USING NON-ZERO-DIFFERENCE COMPARABLES, filed: Jul. 10, 2018, U.S. Non-Provisional patent application Ser. No. 16/031,886, titled System and Apparatus for the Display and Selection of Listings and Splits; U.S. Non-Provisional patent application Ser. No. 16/031,860, titled DEFAULT VENUE MAPS, filed: Jul. 10, 2018.

There exists in the art the need to accurately evaluate and price non-identical inventory. While the art is replete with approaches used to determine an absolute price for an inventory item, there is no consistent, automatic way of displaying a dynamically adjusted price of non-identical inventory, in real time, based on contemporaneous pricing information of non-identical inventory.

For instance, in the event ticket and resale industry there is a need for, and a lack of, dynamic pricing adjustment feeds for non-identical inventory. The event ticket industry in the United States is a roughly $60 billion marketplace where tickets for events are exchanged among brokers and consumers. Often, these exchanges are predicated on both parties having accurate, and up-to-date pricing information.

The ticketing industry is currently divided into a primary market that performs an initial listing of tickets, and a secondary market where ticket brokers exchanges of the listing between the primary, other secondary market brokers, and consumers. The primary market lacks price liquidity, using a fixed set of prices over large quantities of listings. The secondary market brings liquidity through the use of dynamic pricing of the tickets to meet consumer demand.

Automated pricing technology, commonly called auto-pricing, is used to automate price within these secondary online inventory marketplaces. For example, in the ticket marketplace, automatic pricing technology is used to address the fact that each ticket is unique (there is no identical ticket for a given event), and that there are potentially thousands of price points for a single event. For instance, a seat in a preferred row at a given venue is different from an identically numbered seat at a different venue. Alternatively, any one seat in a given venue is different from all other seats in the same venue, even when both seats are spatially close together. However, the eventual consumer perceives little difference in value between these two seats and assigns them roughly the same price. Alternatively, consumer tend to place a higher value on a ticket in the first row unless there is excess first row inventory available. Thus, there are price variations in the primary and secondary market that are driven by non-identical item comparison.

Thus, it becomes advantageous to have, or be provided with, visual indicators of data values associated with the price of non-identical inventory. In a dynamic market where automated software is pricing listings continuously in response to real-time inventory date, users (i.e. brokers) need a similarly automated mechanism to implement purchasing and selling activities. Thus, the introduction of automated, computer mediated price discovery has caused a corresponding need for users to be able to rapidly and accurately process those pricing differences.

Furthermore, what is needed in the art, are various systems, methods, apparatuses, and computer products that provide users with access to data feeds in an interactive and visually distinct manner such that various trading strategies can be implemented using a common interface. What is also needed in the art is a common real-time, price display mechanism that allows for rapid, continuous manipulation of pricing information that is being generated by an automated system such that inventories of any size might be managed.

Likewise, what is also needed in the art are systems and methods for dynamically determining and setting the price for non-identical inventory that permit the user to retain flexibility with regards to the underlying data relied upon to dynamically price such inventory.

While the present examples use the event ticket industry as an example because it highlights that pricing has many layers of complexity, the same pricing decisions are made in other industries. For example, rental property pricing has similar complexity in comparing non-identical inventory. Here, every house on the beach is different, but lowering the price of nearby rentals gives potential renters options that guide the actual market value of any given rental.

### SUMMARY OF THE INVENTION

The following summary of the invention is provided to give a basic understanding of some aspects and features described herein. This summary is not an extensive overview, and as such it is not intended to particularly identify key or critical elements of the systems, methods or apparatus described, or to delineate the scope thereof. Its sole purpose is to present some concepts in a simplified form as a prelude to the more detailed description that is presented below.

In one or more implementations, a system is provided for updating pricing data for an item based on pricing data from non-identical items or inventory, the system comprises at least one processor configured with code executing therein, a memory for storing the code and a communication linkage that permits the processor exchange data with at least one database of references to inventory available for sale. The processor, in one configuration, implements or generates a filter protocol using one or more pre-set filtering criteria. The processor is further configured to store the generated filtering protocol in one or more databases for further use. Additionally, the processor is configured to retrieve pricing data for the inventory from an inventory data base or an inventory exchange server. The processor is further configured to filters pricing data retrieved from the inventory database or inventory exchange server using the filtering protocol. Additionally, the processor is configured to calculate a price for the item based on the filtered dataset and in response to the application of a pricing rule accessed from a local or remote memory storage location.

In a further non-limiting implementation, a method is provided for updating a data set that corresponds to the price of an inventory item, where the data set is stored in an electronic database. In one implementation, the method includes using at least one processor configured with code executing therein and having an associated memory to implement a series of protocols or action related to evaluating the data set and displaying the data set to one or more remote computer or display devices.

In one configuration, the protocol or actions include generating a filtering protocol using one or more pre-set pricing criteria and storing the filtering protocol in a database. The processor is further configured to carry out steps related to retrieving pricing data for comparable inventory from an inventory exchange server. Additionally, the processor also includes a step of filtering the retrieved pricing data using the filtering protocol and calculating a price for inventory based on the filtered dataset is performed by a suitably configured processor. In one or more additional configurations, as further step of updating the price reference reflect the newly calculated price is also performed by the processor. In yet and additional step, the processor is configured to transmit the newly calculated price data to one or more remote displays.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram illustrating particular elements according to one embodiment of the present invention.

FIG. 2A is a flow diagram illustrating particular steps according to one embodiment of the present invention.

FIG. 2B is a flow diagram illustrating particular steps according to one embodiment of the present invention.

FIG. 2C is a flow diagram illustrating particular steps according to one embodiment of the present invention.

FIG. 3 is a block diagram illustrating particular elements and modules according to one embodiment of the present invention.

### DETAILED DESCRIPTION OF CERTAIN EMBODIMENTS OF THE INVENTION

As used throughout, the term “inventory” or “item” may apply to any marketable commodity or item, real or virtual. For instance, in the present disclosure, inventory refers to tickets or admissions to various entertainment or sporting venues. However, those possessing an ordinary level of skill in the requisite art will appreciate that the term inventory can be applied to any such goods or services that can be exchanged, traded or otherwise marketed.

Furthermore, the term broker is used to generally refer to the person, persons or entity that controls the pricing of a product, including listings, and that broker includes any agent or software that is employed in pricing. The term “comp” is used herein to refer to a comparable item on the market, and the term “comping” to refer to calculating a potential price for an item based upon the price of comps in the market. Furthermore, additional rules implemented by the one or more processors that operate to exclude a subset of comparisons as are referred to as “exclusions”, and the computed factors that make a comp an exclusion as “exclusion rules.”

The present systems, methods and computer products described herein provide a solution to pricing non-comparable items using purely algorithmic strategies and providing those pricings solutions a collection of visual identifiers and markers on a remote display or computer. Furthermore, since pricing strategies that are purely algorithmic fail to allow the broker to leverage their own knowledge and experience, the present implementations also are directed to a user interface that allows the user to receive the real-time pricing data but also manipulate the data to augment the purely algorithmic approach.

More specifically, various embodiments of the systems and methods described herein are directed a computer system configured to implement a non-zero difference comparable pricing mechanism. More particularly, systems, methods, computer products and apparatus described herein are directed to automatically or autonomously assigning price values to products, such as event tickets, based on comparisons to comparable, but non-identical, products currently on the market. Such computer mediated comparisons are adapted or configured to exclude one or more items from a comparable items list, when, upon further evaluation, the excluded items are determined to not be comparable.

In one or more implementations, code is executed within one or more processor(s) 102 of a computer system 100 that evaluate an inventory of items for sale (such as a database of all items for sale for a given date or event) according to one or more rules or algorithms, so as to determine and identify to the user which items listed in a marketplace are true comparable data and to exclude those items that are not truly comparable.

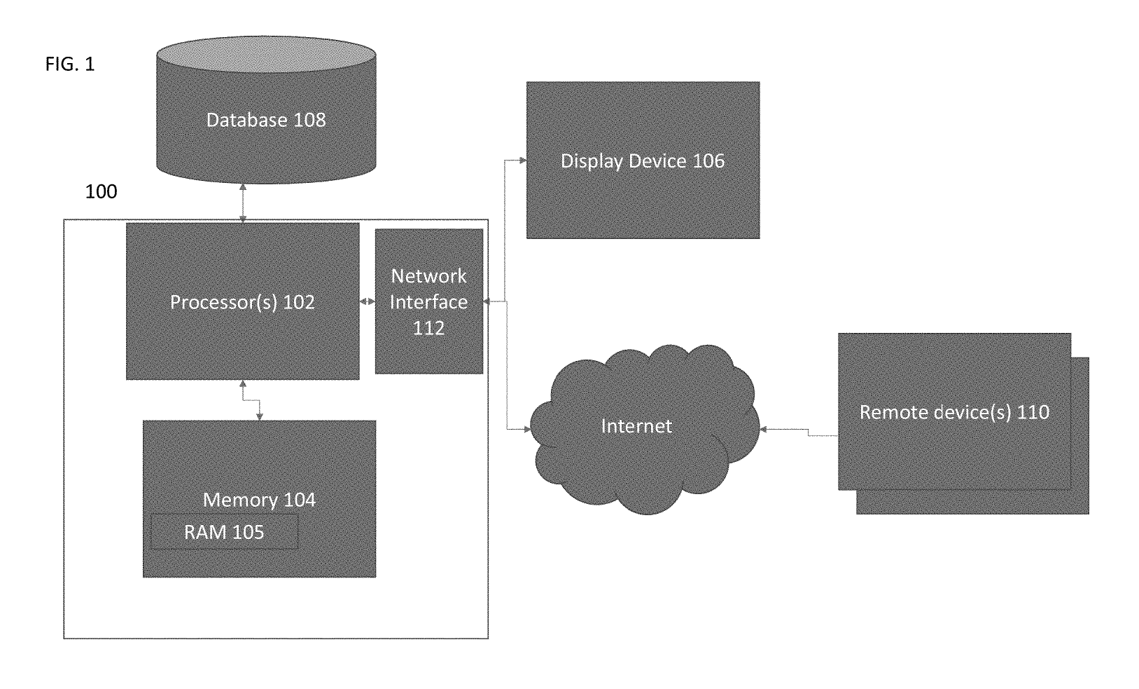

With respect to FIG. 1, a computer system 100 is one or more processors 102 configured to execute a commercially available or custom operating system, (i.e. MICROSOFT WINDOWS, APPLE OSX, UNIX or Linux based operating system) to carry out instructions or code. In one or more configurations the processor 102 is a multi-core, single core, multi-processor, cloud based or other configuration of processor elements or microprocessors.

Likewise, remote device 110 is comprised of one or more computers, processors, or microprocessors such that the remote device is configurable to send, receive and process data from database 108 and or computer system 100.

In one or more configurations, both the remote device 110 and computer system 100 are workstations, thin clients or portable computing device such as an Apple iPad/iPhone® or Android® device or other commercially available mobile electronic device configured to receive and output data to or from database 108 or other memory storage devices.

As shown, memory 104 and persistent storage 108 are examples of computer-readable tangible storage devices. A storage device is any piece of hardware that can store information, such as, data, program code in functional form, and/or other suitable information on a temporary basis and/or permanent basis. In one or more embodiments, memory 104 includes random access memory (RAM) 105. RAM 105 may be used to store data such as the venue data in accordance with the present invention. In general, memory 104 can include any suitable volatile or non-volatile computer-readable storage device. Software and data are stored in persistent storage 108 for access and/or execution by processor(s) 102 via one or more memories of memory 104. With respect to remote device 110, for example, software and data are stored locally on the remote computing system.

In a particular embodiment, persistent storage 108 includes a magnetic hard disk drive. Alternatively, or in addition to a magnetic hard disk drive, persistent storage 108 can include a solid state hard drive, a semiconductor storage device, read-only memory (ROM), erasable programmable read-only memory (EPROM), flash memory, or any other computer-readable storage devices capable of storing program instructions or digital information.

The database 108 may be embodied as solid-state memory (e.g., ROM), hard disk drive systems, RAID, disk arrays, storage area networks (“SAN”), network attached storage (“NAS”) and/or any other suitable system for storing computer data. In addition, the database 108 may comprise caches, including database caches and/or web caches. Programmatically, the database 108 may comprise flat-file data store, a relational database, an object-oriented database, a hybrid relational-object database, a key-value data store such as HADOOP or MONGODB, in addition to other systems for the structure and retrieval of data that are well known to those of skill in the art.

The media used by persistent storage 108 may also be removable. For example, a removable hard drive may be used for persistent storage 108. Other examples include optical and magnetic disks, thumb drives, and smart cards that are inserted into a drive for transfer onto another computer-readable storage medium that is also part of persistent storage 108.

Communications or network interface unit 112, in these examples, provides for communications between the processor 102 and other sub-systems or devices, such as the remote device 110. In one implementation, communications unit 112 may provide appropriate interfaces to the Internet or other suitable data communications network to connect to one or more servers, resources, API hosts, or computers. In these examples, communications unit 112 may include one or more network interface cards. Communications unit 112 may provide communications using either or both physical and wireless communications links.

In one or more configurations, computer system 100 and/or the remote device 110 include one or more display devices 106. In a particular implementation, the display device 106 provides a mechanism to display data to a user and may be, for example, a computer monitor. For example, display device 106 also functions as a touch screen, such as a display of a tablet computer. In one or more implementations, the display device 106 is a separate computing device that is in communication with the system 100 and/or remote computer 110 and is operative to receive data and display the received data.

In one or more configurations, the presently described systems, methods and computer products are configured to generate a data values for incorporating into a user interface that is displayed on the display device 106 of the computer 100 or remote computer 110, that allows each respective user (i.e. broker) to access the current pricing information for a given event. Such a user interface also is configured to be updated in real time to be responsive to changes in the market, and the user's owner data manipulation. Through such a system, the user is enabled to leverage the automatic pricing technologies to enable different pricing strategies without tightly coupling each inventory item to one or more trading ranges.

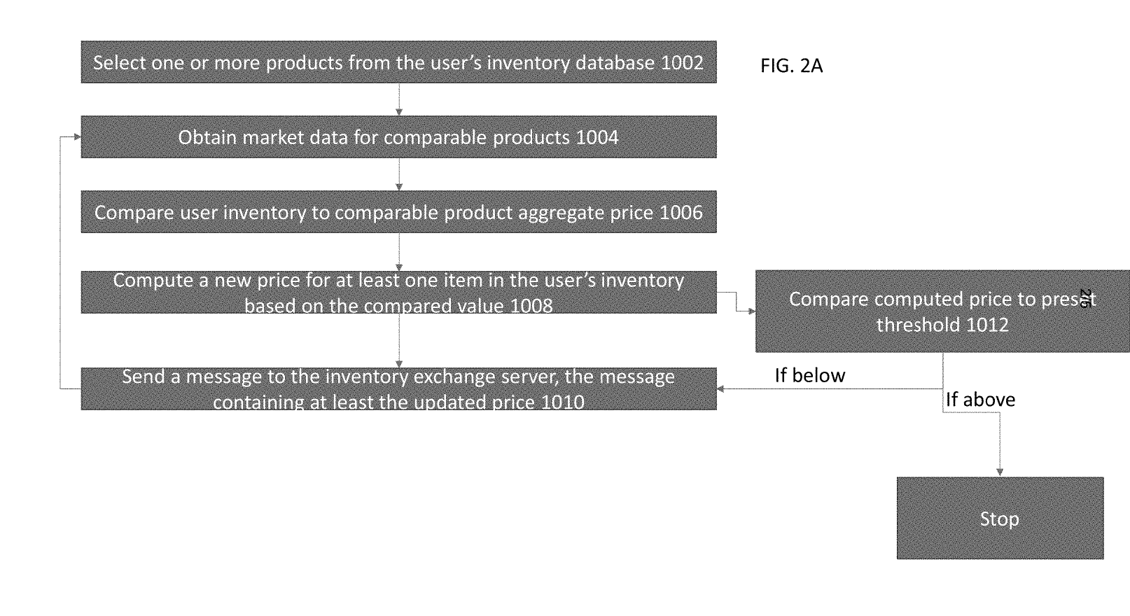

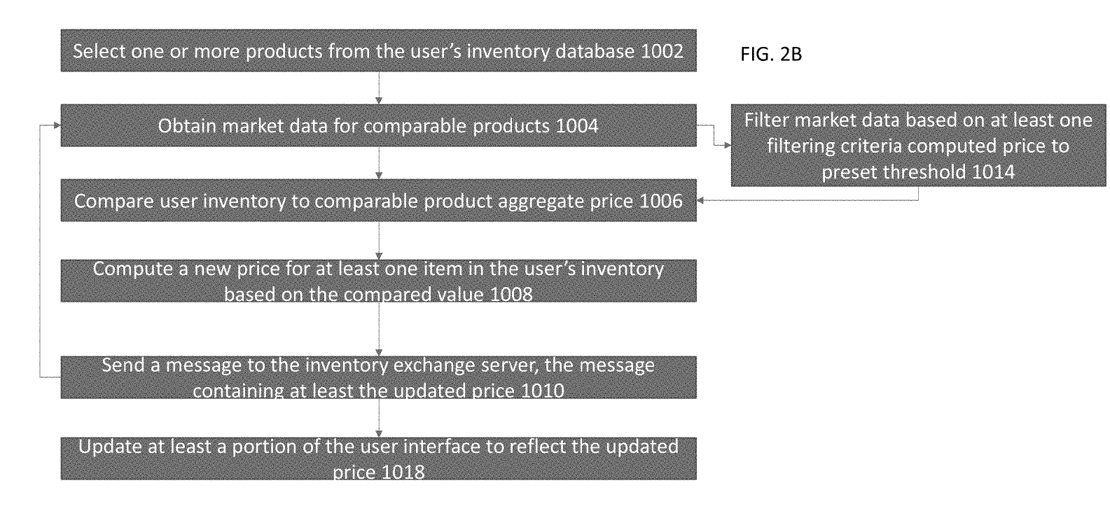

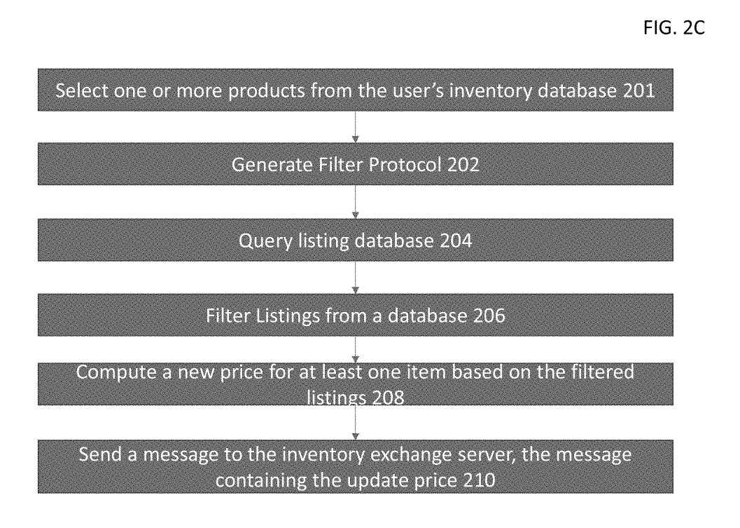

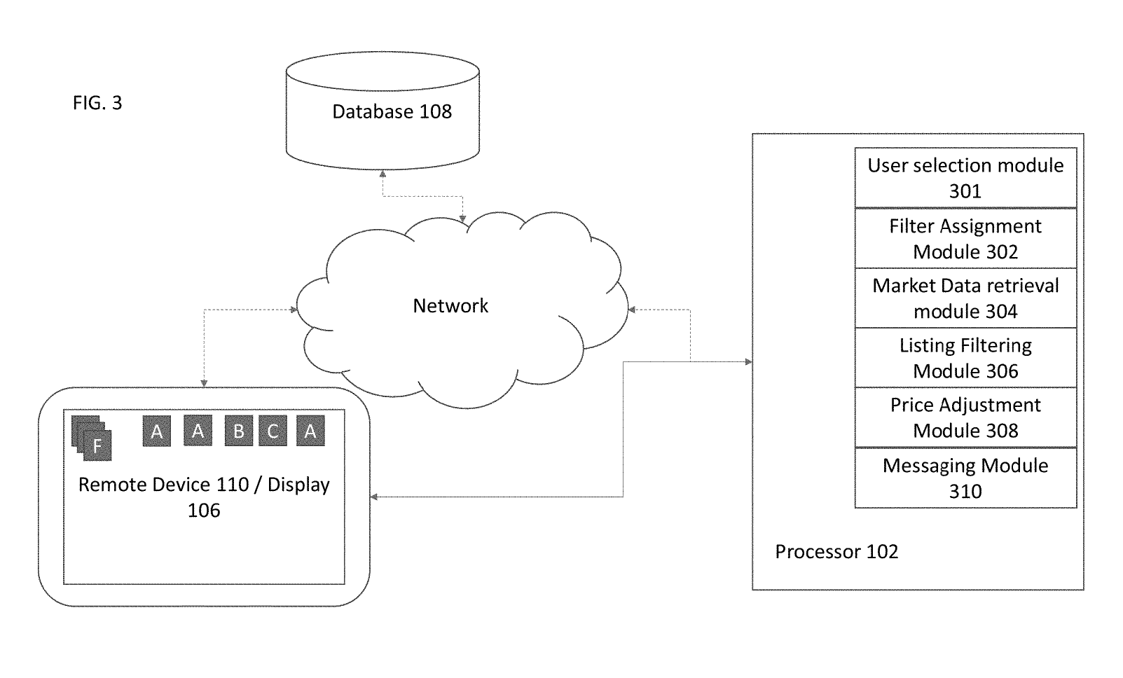

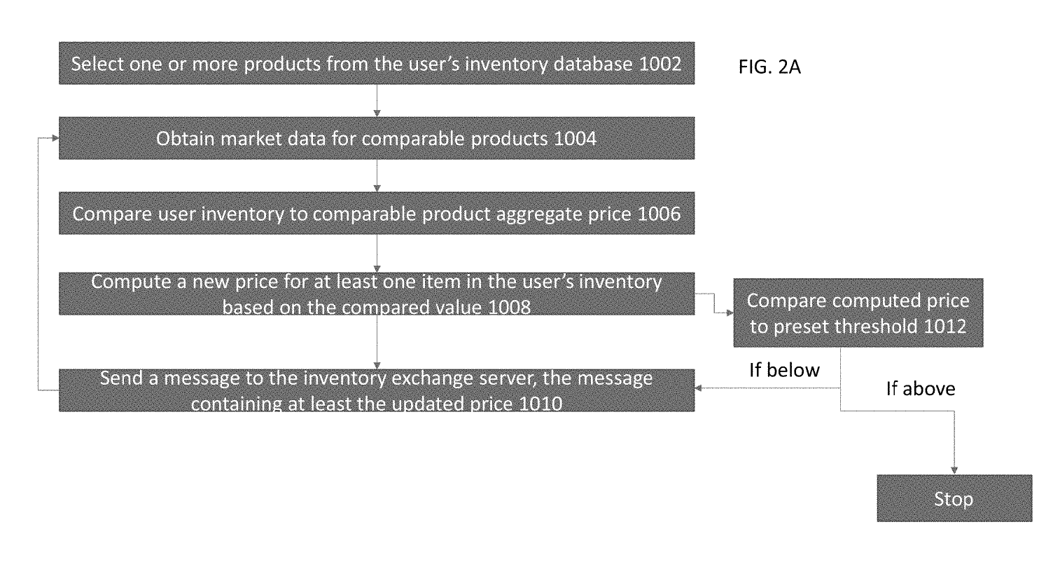

By way of non-limiting example, outlined in FIG. 2A, consider Broker A and Broker B each utilizing the computer system 100 and having a graphical display provided on their respective remote computing devices 110. Both Broker A and B have respective inventory listings (such as provided in an inventory market place represented by database 108) that correspond to a particular section of an event venue (for example row 4 of the same section) as determine by querying a market place database as in step 1004. Now, assuming that the listings are otherwise identical, except for the exact seats contained in each group, there is a reasonable expectation that both items should have approximately the same value assigned to each item by every consumer. However, Broker A has configured one or more processor(s) 102 of the computer system 100 to implement a pricing strategy of undercutting the established ticket price of its inventory (that is, a value that similar tickets are currently offered at based on the values stored in database 108) provided on an electronic exchange (i.e. database 108) by $1 as shown in step 1006. Broker B implements or causes computer system 100 to also implement the same strategy. For instance, all the other comparable tickets (i.e. listings for the same general location at the same time) are priced around $50. In the first iteration of calculating price, when done purely algorithmically, Broker A and Broker B both assign a price of $49, undercutting that current listing by $1 as shown in step 1008. After a pre-determined time interval, when the automated process checks the listings again, processors (such as processor 102) are configured to receive pricing data for Broker A and Broker B each receive data corresponding to the price changes of the other broker's listing, such that both instances of computer 100 have received the new $49 listing of the other Broker. In response, both the system implementing Broker A strategy and Broker B's strategy will in turn, undercut the price of the respective inventory to $48 and update the market place (database) of the new pricing values, as in step 1010.

The respective instances of computer 110 (one for each broker) repeat this strategy by carrying out the steps of accessing market data (step 1004) evaluating the current price of the inventory against the market data (1006), after a pre-set interview, of the user's inventory and then setting new price that is less than the lowest market price available for comparable inventory accessed from database 108. Thus, process implemented by computer 100 (or multiple instances or versions thereof) repeat, causing the price of each to race downward such that the price of both tickets if not actively monitored will reach $0. However, in practice, pricing technology, such as Broker Genius Auto-Pricing software platforms provided, by Broker Genius of Far Rockaway, N.Y. and includes functionality necessary to assign a price floor that halts the updating of prices if the new price is below a pre-set threshold. In practice, if multiple brokers are using the same technology, then the broker having the preset lowest floor threshold value will have the lowest ticket price at the end of successive iterations. By way of further example, if Broker A provides a threshold value of $20 to a suitably configured price processing system, and Broker B's threshold for the same or a similar pricing system is $19, then Broker A's listing will ultimately settle to $20, and Broker B's listing will settle at $19. As a result, both Broker A and Broker B have comparable inventory that is priced well below current market price of $50.

One approach to overcoming this problem endemic to electronic price setting of inventory is to tightly manage their threshold values. For instance, in one configuration, if Broker A sets the pricing threshold value to $45. Thus, if as shown in step 1012, if the computed new price is below, and the entire market (i.e. all the comparable items offered for sale) drops price to $40 or lower, Broker A's inventory is priced above the market, resulting in a low likelihood of a beneficial transaction. However, if Broker A doesn't set the floor tightly to the overall market price (i.e. tightly couple the floor to a range tightly bound to the actual market price) than Broker B (or any other number of Brokers operating in the market) can push Broker A's price down to its pre-determined floor. Thus, one of technical challenges encountered when deploying internet-based pricing systems is that other market participants can innocently or otherwise, use the automated pricing platforms to depress item prices to the lowest value set by the user.

In one or more configurations, the systems, methods and computer products described herein address solution to the problems encountered when utilizing automatic pricing technologies. For instance, the systems, methods and computer products described herein are directed to the identification, classification and filtration of inventory items such that comparable groups of inventory items can be visually identified and modified such that pricing data and positions can be protected from unintentional or malicious pricing divergence.

With additional reference to a problem rooted in the use of computer or network-based item exchange pricing platforms can be addressed with reference to the illustrative example provided herein. Assume an inventory merchant (here in referred to as a broker) is listing tickets in both rows 4 and 6 of a venue section, and that the broker desires that the price of the ticket to be $1 less expensive than other tickets in rows 4 through 10 in that same section. The broker could not possibly price both the 4th row listings and 6th row listings $1 less than the other. In such cases, all else remaining equal, the broker would in effect exclude their own listings from the comparison group. Also, the broker may notice that all listings in the area are priced $50 or more, yet one listing is priced at $15. The broker may reasonably exclude the $15 listing as undervalued, and either purchase it to re-list closer to market value, or simply ignore it when pricing their inventory. For example, in one or more configurations the processor 102 or computer system 100 is configured to identify comparative items based on a first filtering criterion, and then uses successive filtering criteria to eliminate non-comparative items from the list of inventory provided by the inventory database 108 as shown in step 1014 of FIG. 2B. In one configuration, the user interface provided on the remote device 110 or display device 106 is configured to change the appearance of a listing to indicate that it is above or below the market value for similar inventory or that the item in question has reached the threshold limit. In a further implementation, the user interface is configured to generate a second visual change in the configuration of elements displayed to a user to indicate that the aggregate market price of comparable inventory (for example a mean price of the comparably inventory) has moved below the threshold value or limit set by the user as in step 1018.

For instance, where a price of an inventory item is more than 1 standard deviation above or below a mean market price for similar inventory items, the visual element of the graphical user interface provided to the user will indicate such a divergence. For instance, an icon or other representation of the divergently priced item is changed to reflect it relative value with respect to the other inventory. Such a color, size, or orientation change can visually indicate the overall or degree of divergence between a given inventory item and the mean market price of similarly situated items.

However, such rules cannot be strictly defined and uniformly applied. The Broker has no way of determining in an electronic exchange whether a $40 ticket listing is undervalued, or correctly valued, or overvalued in the relevant market. Likewise, if there are three inventory items (i.e. tickets) listed at $25 each, and demand is expected to be reasonably low, the broker may be unable to correctly deduce the optimal offering price in the electronic exchange.

An ad-hoc strategy used by many in the secondary market is to base prices on similar listings. For instance, for a ticket in a certain row of a certain venue section, a listing agent will often consider the prices of listings in similar rows and sections, and assign a price based upon available listings in the market. This is an attempt to divine the intention of potential purchasers, by considering that purchasers will typically compare the prices of similar listings when making a selection and apply some type of ad hoc utility function based upon a perceived value of the listings. There exists software (such as the pricing technology sold by Broker Genius) that automates the comparison of listings to similar listings, monitors those listings in the market, and updates price accordingly. A broker can select a group of sections and rows within those sections, set a rule such as “charge 1% less than the lowest price listing in that group”, and have that criteria applied on their behalf, every few minutes, to update the price assigned to their listing. In both the automated and ad hoc methods, it is normal to exclude listings owned by the listing entity that otherwise would be valid comps, as well as items that represent significant outliers in terms of price (i.e. more than 1 standard deviation above or below the mean aggregate ticket price). Thus, the presently described systems, methods and computer products are directed to overcoming some of the drawbacks inherent in electronic item price management by utilizing an iterative filtering process to eliminate non-comparable items based on a collection of item characteristics. For instance, turning to FIG. 2C, in step 201, a listing is selected for pricing. Selection may be done, inter alia, by means of a UI, or upon uploading to a system capable of such pricing, or through an Application Programming Interface (API) or similar interface. For example, a user of the remote device 110 is configured to exchange data with the computer system 100 to effectuate the selection of a listing stored within database 108.

As an initial matter, as user is prompted by the system 100 described to select one or more of the user's inventory for dynamic pricing. As shown in step 201, the user causes a properly configured processor 102 to select from the user's own store of inventory, items to be dynamically priced. In one implementation, a user might select one item manually for dynamic pricing. In another implementation, the user might select all the user's inventory for dynamic pricing. In yet a further configuration, the processor 102 is configured by code to select additional items in a user's inventory based on a given criteria. For example, the user might select all inventory that has an impending expiration date. Here, the properly configured processor 102 selects all other inventory items having a similar expiration date. Alternatively, the user provides a description of items desired for dynamic pricing. Here, using one or more natural language processing or machine learning algorithms, the processor 102 is suitably configured to select additional items meeting or complying with the description.

In one or more configurations, such selections are carried out by a User Selection Module 301 that configured the processor 102 to receive the selection criteria from the user and obtain references to the items desired to be selected by the user. For example, where the user is making selections using a remote device 110, the remote device 110 does not need to have a direct connection to the inventory server 108. Instead, the processor 102 is configured to exchange data with the inventory exchange server such that the bandwidth requirements between the remote device and the processor 102 are minimized. Thus, a processor 102 of the system 100 is configured to retrieve from the database 108 a collection of the user's inventory and generate a dataset causes the user interface of the remote device 110 to display various elements (tables, spreadsheets, visual icons) that correspond to the user's inventory data that is stored in the item exchange database 108. The user, in turn, is then able to make selections based on this reference data, without needing to be directly connected to the item exchange database (i.e. database 108).

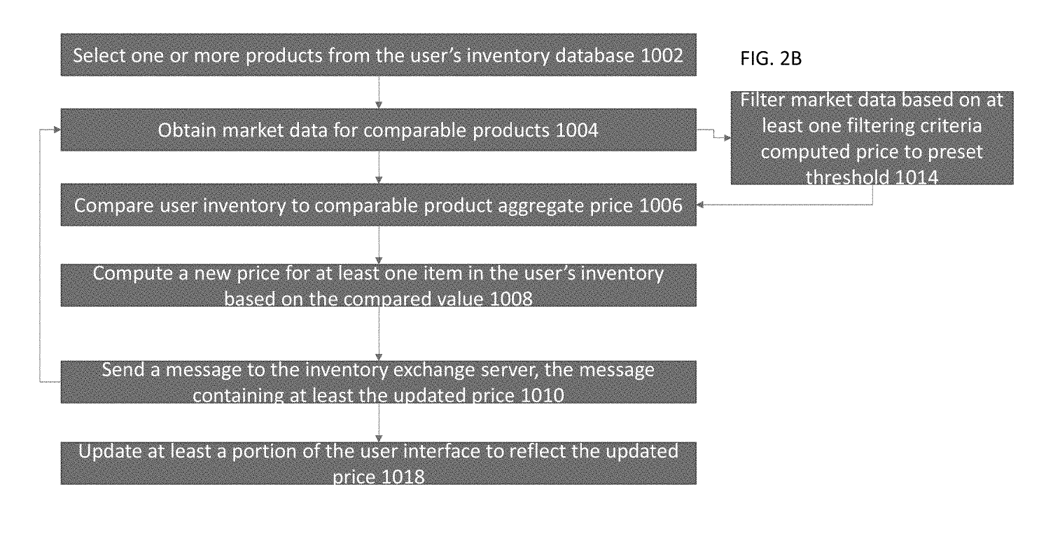

Moving to step 202, upon selection of the inventory data, one or more filtering protocols are devised or obtained that are operative to exclude some portion of market data from any comparisons with the selected items. In one or more implementations, the processor(s) 102 of the system 100 described herein are configured to generate a selection of interactive elements (referred to as elements A, B and C of FIG. 3) on a display 106 provided to the user. The interactive display elements generated and provided to the user each include functionality that informs the processor 102 how to filter queried market data.

In one or more implementations, the generated interactive display elements (A-C) correspond to functionality implemented by the processor(s) that causes market data to be filtered or otherwise compared against the user's inventory. In one particular arrangement, such a comparison utilize a price threshold value to set the comparison or filtering criteria. For instance, the user may select for inclusion into the filtering protocol a function that removes all market data that reference prices for inventory that are outside of a specific or defined range. Such a defined range may be absolute (e.g. between $30 and $60 dollars) and/or relative to one or more of the user's inventory (e.g. no more than 20% greater or lesser than the current price of the user selected inventory item).

Additional functionality provided to the user through the generated user elements. For example, the user is able to assign a filters to a user element that restricts or removes market data based on black-listed or white-listed suppliers. Here, the entity listing the item on an exchange might be known to either provide dubious pricing or reliable pricing and the user is provided with the corresponding functionality.

In one or more further implementations, the provided functionality can include an interactive element that causes the processor 102 to provide filter functionality based on the frequency of price updates applied to the product.

In addition, or alternatively, the processor is configured to provide to a user an interactive element that causes the processor to filter market data based on the regularity of price updates applied to the product.

The processor is further configured to provide to a user an interactive element that causes the processor to filter market data based, in part, on if a given inventory item was not entered into the market by means of a point-of-sale (PoS). In yet additional functionalities, the processor is configured to provide to a user an interactive element that causes the processor to filter market data based on meta data associated with specific inventory items (such as date, price, time, or other associated data).

It will be appreciated that the processor 102 is configured to provide some or all the described functionality to a user by means of a user interface, where the user interface includes one or more combinations of selectable elements that provide the functionality of any combination of the foregoing filtering protocols. Thus, in one or more implementations, as shown in step 202, a user (e.g. a broker) is provided with a collection of interactive display elements that permit the filtering of market data for the purposes of selection of comparable inventory to accurately price the user's inventory.

However, in one or more further implementations, functionality is provided to a user that enables the user to combine the functionality of several filter functions into a single filter “protocol” (represented by element F). For instance, the user interface is configured to allow the user to stack or otherwise associate a collection of visual identifiers for filtering functions (A-C) into a single protocol F that can be executed against one or more of the items in the item inventory.

Turning to more detailed examples, a filter assignment module 302 configures the processor to generate filter functions for use by the user. In one implementation, the filter assignment module 302 configures the processor 102 generate a function that, when executed by the processor 102, will filter the market data based on statistical outlier detection. A statistical outlier can be defined as a price that is some distance from the market. However, a fixed definition pre-determined by some automated process does not allow one broker to leverage superior pricing knowledge over another broker.

Through the use of the filter visual elements, a user interface is constructed that allows a broker to control the various characteristics of the filter module. For example, the user is able to alter any of the internal variables or parameters of each filter function, such as permitting the user to alter the parameters that define a pricing outlier and have a user interface that includes a collection of icons or identifiers that represent the custom or pre-determined functions selected or developed.

For instance, when the user selects a filtering module, a separate window, interface, or icon is provided which allows a user to pick the n lowest listings from a set of comps, and the specify a percentage p or dollar value d. The system 100, or a processor 102 thereof, is configured to generate a function that when executed by the processor 102 takes the average of the n lowest priced listings from the event, takes the average, and excludes any listing that is either p percent lower than the average, or d dollars lower than the average as an outlier. In another embodiment, the user simply specifies the number of listings n, and the n lowest listings are excluded.

As a brief aside, it is important to note that the data obtained from the item database 108 includes values associated with a particular item that represent additional features or characteristics of the item. These additional features or characteristics, while not pricing data, do have a material impact on the perceived quality value of the item. For instance, the data for an inventory item may indicate whether the item (when it is an event listing) has an obstructed view of the stage. Additionally, the data values received from the database 108 may include data directed to whether the item is associated with an indirect purchase inducement, such as free parking or shipping, that are not included in other listings and are not directly related to the price of the item. Such analysis and determination take indirect quality modifiers also into account. For example, in the ticket event inventory field, ticket quality can be based or derived, in part or in whole based on the particular date, section, row and event type referenced by the ticket. However, even amongst tickets at the same venue, the type of event might cause a quality determination to favor one or more factors over another. By way of clarifying example, in a National Football Game (NFL), a front row seat in a section on the 50-yard line is most desirable, whereas a theater ticket may not favor front row, which has a distorted view of the stage.

In an alternative configuration, step 202 includes one or more sub steps that permit the user to generate filter functions that when executed will filter or manipulate market data (such as data obtained from the item exchange server and database 102) based on quality outlier detection. By way of introduction, quality detection is the comparison on value judgements made regarding compared inventory. For instance, just as one needs to price against comparable seats based upon row and section, one needs to make pricing determinations (e.g. comp) against items having comparable quality. It will be appreciated that quality data for the inventory is specific to the type of inventory.

Here, a comp may choose to exclude or include any item listing that has one or more of a given property or collection of properties. In one or more implementations, based on the data associated with the processor 102 provides to the remote device 112 a visual icon or identifier that corresponds to a function that, when executed by the processor 102 removes items from the query that have one or more of the following characteristics: whether the seats have an obstructed view, whether the seat is wheelchair accessible, whether the section is alcohol-free, whether a parking pass is included, whether the seats are divided between multiple rows (known as “piggyback” to those with ordinary skill in the art), whether a seat is on the aisle, whether these are partner-sponsored seats, whether other perks are included, whether these tickets are limited to use by students, youth, child, or faculty, and others.

For example, the described system provides to the user, one or more selectable elements that, upon selection, configure the processor to selectively include or exclude each of the above reference quality indicators. For instance, the processor 102 of the system 100 described is configured to remove all of the listings from the query of the market data except for those results that reference items that included a pre-selected indirect quality and direct quality value, such a including only tickets coming with a parking pass and excluding form the filtered results, tickets having an obstructed view.

In another implementation, step 202 includes one or more sub steps that permit the user to filter the market data based on listing entity. In one or more implementations, multiple users are executing transactions using a common service provider. In instances where the service provider is providing roughly equivalent service for each of its users, it becomes advantageous to exclude those other user's inventory listings from the query results. For instance, where it is known that a listing of Items 1, 2 and 3 belong to Seller A, and that Items 4, 5 and 6 belong to Seller B, it can become advantageous for and both A and B to exclude each other. In the context of event ticket sales, where Seller (e.g. Broker) A and Seller (e.g. Broker) B are using the same auto-pricing technology, it is possible and that the Brokers will enter a “race down” condition as described above. Accordingly, pricing for either Broker A or Broker B, all of listings 1, 2, 3, 4, 5 and 6 may be excluded from the comparable group. It may also be advantageous for Broker A to exclude Broker B, while Broker B does not exclude Broker A. This is true, for instance, if Broker B is known to undercut pricing substantially, and Broker A believes that future demand for these listings justifies selling at a future date, allowing Broker B's inventory to sell off now. In such cases Broker A still wishes to be priced according to the market but does not believe that Broker B is estimating that value correctly. Broker A may also realize that Broker B is intentionally undercutting aggressively to cause a sell-off to Broker A's inventory. Such unilateral exclusion makes that strategy ineffective.

In yet a further example, step 202 includes one or more sub steps that permit the user to filter the market data based on frequency of price updates. Here, Broker A and Broker B may not know explicitly that the other is auto-pricing, as in the previous example. However, the use of automated systems can leave data artifacts that may allow either Broker to detect that another party is using auto-pricing, or frequent manual pricing.

Thus, in one implementation the processor 102 is configured to implement an auto-price detection (APD) routine to exclude listings from comping. Furthermore, APD routines may be used as part of the price updating process described herein and permit the user to dynamically alter inventory prices applied to a listing. In the simplest case, the listing is excluded from the comparable group. For another implementation, consider the case in which that Listing 1 is known to by APD to be auto-priced. In this case, Listing 2 adjusts price until Listing 1 stops being auto-priced, likely because Listing 1 has reached a floor. Listing 2 then, in effect, holds Listing 1 at that floor until Listing 1 is sold. This will quickly allow Listing 2's price to anchor against higher priced inventory. In effect, Listing 2 is undercutting the market, but not undercutting a listing that is lowered below a certain threshold.

However, in the previous example the listing price is not a hard floor price and Listing 2 will continue to lower in price if another, non-auto-priced listings lower in price. This series of events indicates that the market has moved downward, i.e., that this is not a race-down condition. Instead, the scenario represents an overall adjustment in the market price. In one or more implementations, the processor 102 is configured to automatically identify or flag any entries returned in a query or market data as subject to auto-pricing when any of the following occur:

1. The price has updated 8 or more times in the past 24 hours;

2. The price has updated 4 times in the last 60 minutes.

3. The price has updated 3 times in the last 20 minutes;

4. In the past 8 hours, if there has been any change in the venue zone aside from the listing, the listing has also changed each time, and there have been at least 3 changes in the market.

Furthermore, the processor 102 is further configured to unflag an entry as subject to auto pricing whenever all these criteria fail to be true.

In yet a further example, step 202 includes one or more sub steps that permit the user to filter the market data based on regularity of price updates. Here, similar to the frequency of price updates, a suitably configured processor 102 is configured to generate a filtering protocol that when executed, identifies a listing that is subject to auto pricing. However, the signature identified relates to the regularity of price changes for a given item. Such regular price changes can be indicative of an automated procedure being used to update the items offering price. In such cases, APD may indicate that a listing is auto-priced even though none of the above procedures would otherwise indicate auto-pricing, given the thresholds discussed above. In one configuration, a listing is flagged by a suitably configured processor 102 as auto-pricing when any of the following occurs: The price has updated 4 times, at t0, t1, t2, and t3. The price differences are calculated at d1=t1−t0, d2=t2−t1 and d3=t3−t2. The second pairwise differences, p1=d2−d1 and p2=d3−d2 are computed. If each of p1 and p2 are less than each of d1, d2 and d3, then the signal is flagged as auto-pricing. For example, in a hypothetical case A auto-pricing is detected. t0=10, t1=21, t2=30, t3=40 d0=11, d1=9, d2=10 p0=2, p1=1 (p0, p1)<(d0, d1, d2): auto-pricing t0=10, t1=15, t2=40, t3=90 d0=5, d1=25, d2=50 p0=20, p1=25 p0>d0: corresponds to auto-pricing not being used.

In the foregoing example, the processor 102 of the present system is configured to take a first and second derivative of the time updates, and auto-pricing is said to be true when the second derivative is trivial, where “trivial” is defined as “smaller than the first derivative. Thus, the processor 102 is configured to consider variations in the time measurements where those variations are less than the interval between time measurements.

In yet a further example, step 202 includes one or more sub steps that permit the user to filter market data based on point of sales usage patterns (PoS). The websites that list tickets for sale (exchanges) track whether the listing has been uploaded through a point-of-sale (PoS), or manually. Manual uploads are typically from consumers or smaller brokers, and their pricing performance is often erratic and not based on market conditions. When pricing relative to an exchange, excluding inventory not entered through a PoS is an effective means of providing a stable price that reflects the market more accurately. It should be appreciated that poorly priced inventory is often quickly purchased by another broker as an arbitrage opportunity. Undercutting a poorly priced listing leaves a broker vulnerable to having their inventory arbitraged.

In yet a further example, step 202 includes one or more sub steps that permit the user to filter market data based on a selection of specific listings by a user though the user interface. A broker may select, using the processor 102, a listing to exclude even though the listing is not captured any of the above criteria. For instance, a listing for a pair of tickets may include free parking, and there may be no method in the interface to exclude tickets that include such perks. Accordingly, a broker may wish to simply manually select that listing based on no other discernible criteria. In addition, the listing itself may be sold and re-listed by another broker. In such a case, the broker will have two options. First, the broker may wish to release the exclusion, and treat the new listing as a comparable unless another rule excludes it. The second is to have the exclusion follow the new listing. In this case, the system would need to track the ticket IDs associated with the listing ID and apply the exclusion to any future listing ID that includes those ticket IDs.

As show in FIG. 2C, upon generating a filter protocol for items, the processor is configured to retrieve market data, as in step 204 from an inventory exchange service or server. In one or more configurations, the processor 102 is configured by a market data retrieval module 304 that causes the processor 102 to query the database 108 and receive the results of the query. In a further non-limiting implementation, the processor 102 is configured by code executing therein to query from the database at least a portion of the references to inventory. As shown in step 204 querying the database includes one or more sub-modules that configure the processor to establish a connection with a remote or local database. In one implementation, the database 108 is a third-party ticket exchange server. Here, the entries in the database are updated in response to users listing inventory on the exchange. In one or more implementations, the querying step 204 includes querying reference data (e.g. inventory data) that includes pricing data associated with the inventory descriptors. In a non-limiting implementation, the query is generated by using descriptive information from the item(s) selected in step 201. For example, the processor 102 is configured to parse descriptive data from the items selected in step 201 and build a database query using the parsed elements of the items selected.

In one particular implementation, the market data is queried over the internet using a provided Application Programming Interface (API). For instance, the one or more additional databases are owned by a ticket exchange (a piece of software designed to exchange tickets between sellers and buyers) and made available through a web-connection, interface or API. Alternatively, the market data source is a collection of entries stored database 108 or in one or more additional databases (not shown).

Upon receipt of the market data, the market data is filtered using the filter protocol(s) selected by the user as shown in step 206. For example, the processor 102 is configured by one or more listing filtering modules 306 so as to generate a new sub-listing of items in the inventory data that meet the filtering criteria.

In one particular implementation, the market data that has been removed due to the filtering protocol is presented in a visual format that differs from the data that passes all of the filtering protocols. In one particular implementation, the processor 102 is configured by code to iterate over the potential filters to determine an optimal number of data points for use in further calculations. For instance, where applying at least all of the above described filters results in market data having too few tickets for useful comparison, the processor 102 is configured to selectively determine which filters can be removed to provide the most data points for analysis.

Upon filtering the market data, the processor 102 is configured to determine a price or updated price value for the user's inventory. For instance, as shown in step 208 using one or more pricing rules, the processor 102 is configured to change the price for a given item by lowering the price a certain percentage range. For instance, a price adjustment module 308 configures the processor 102 of the system 100 to change the data value associated with the user's one or more inventory items so that the new price is below the aggregate mean value of the market of comparable items.

As shown in step 210, a suitably configured processor 102 generates a message based on the determined price and sends the message to an inventory exchange service or server to update the item price. For instance, a messaging module 310 is configured to generate or format a data package or message to be sent to the database 108 that causes the database to update the price data for one or more inventory items that have been adjusted in step 208.

It should be understood by someone with ordinary skill in the art that these specific computations are for demonstrative purposes only, and that the exact algorithm used in the computation may vary based on many factors.

Those possessing an ordinary level of skill in the requisite art will appreciate that the where the present invention is a system, a method, and/or a computer program product, the he computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Haskell, R, Clojure, JavaScript, C#, Swift, Lua, Pearl, Python, Ruby, or the like, and conventional procedural programming languages, such as the “C” programming language, object-oriented programming languages, functional programming languages or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The block diagrams in the illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGs.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments may be utilized in many different types of data processing environments. In order to provide a context for the description of the specific elements and functionality of the illustrative embodiments, are provided hereafter as example environments in which aspects of the illustrative embodiments may be implemented. It should be appreciated that are only examples and are not intended to assert or imply any limitation with regard to the environments in which aspects or embodiments of the present invention may be implemented. Many modifications to the depicted environments may be made without departing from the spirit and scope of the present invention.

While this specification contains many specific embodiment details, these should not be construed as limitations on the scope of any embodiment or of what can be claimed, but rather as descriptions of features that can be specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying FIGs. do not necessarily require the particular order shown, or sequential order, to achieve desirable results. In certain embodiments, multitasking and parallel processing can be advantageous.

Publications and references to known registered marks representing various systems are cited throughout this application, the disclosures of which are incorporated herein by reference. Citation of any above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the claims that follow, the respective features recited in those points, and by equivalents of such features.

1. A system for updating a price displayed to a user of an electronic inventory platform the system comprising:
at least one processor configured with code executing therein, a memory for storing the code and a connection to at least one database of references to inventory available for sale, where in the processor is configured to:
a. access at least one inventory item to be priced, wherein the price of the inventory item is to be accessible to users of an electronic inventory platform;
b. generate a filtering protocol using one or more pre-set pricing criteria,
c. store the filtering protocol in a database;
d. retrieve a plurality of comparable inventory items from an inventory exchange server wherein the listing of comparable inventory retrieved includes a plurality of data parameters associated with each listing and wherein at least one of the associated data parameters of each listing corresponds to the present price that the inventory item is offered for sale;
e. filter the plurality of comparable inventory items using the filtering protocol to generate a filtered dataset;
f. determine an aggregate market price based on the respective prices of the items in the filtered dataset;
g. generate a price for the at least one inventory item based on the determined aggregate market price; and
h. update the electronic inventory platform to reflect the generated price for the at least one inventory item.

2. The system of claim 1, wherein the filtering protocol includes at least two filtering functions that filter the comparable inventory data sequentially.

3. The system of claim 2, wherein the filtering protocol includes a threshold value corresponding to the minimum number of item entries and the processor is further configured to implement a first of the at least two filtering functions and compare the number of items remaining in the filtered dataset to the threshold value and only implement a subsequent filtering function where the number of items remaining in the filtered dataset exceeds the threshold.

4. The system of claim 1, wherein the filtering protocol is generated by receiving a selection of a least two filtering functions from a user remote from the processor.

5. The system of claim 4, wherein the processor is further configured to provide a plurality of references to pre-set filter functions to a remote user device, where the remote user device is configured to provide visual representations of the references to the pre-set filter functions on a display device.

6. The system of claim 5, wherein the processor is further configured to receive at least one filtering protocol wherein the filtering selection represents a combination of at least two of the pre-set filter function sent to a remote user device.

7. The system of claim 1, wherein at least one filtering protocol includes causing the processor to filter the listing of comparable inventory based on at least one non-price-based parameter.

8. The system of claim 1, wherein at least one non-price-based parameter corresponds to at least one of the following parameters that are associated with each listing of the listing of comparable inventory based: auto pricing-based pricing updated, frequency of pricing updates, indirect purchase inducement, Point-of-Sale usage.

9. The system of claim 8, wherein a value for the parameter associated with the auto pricing-based pricing updates is a value calculated by comparing a first-time derived update frequency value against a second-time derived update frequency value.

10. The system of claim 9, wherein the time derived update frequency values are generated according to p1, p2, pn . . . >d1, d2, dn . . . where d1=tn−tn−1, d2=tn+2−tn+1, and d3=tn+3−tn+2 and tn is the time that that a pricing update was made for a given item in the inventory list.

11. The system of claim 1, wherein the filtering protocol includes at least two filtering functions that filter the comparable inventory data in parallel and return the filter dataset having the largest number of item entries.

12. A method for updating a price for an item stored in an electronic database of inventory, the method comprising using at least one processor configured with code executing therein, a memory for storing the code and a communication to at least one database of references to inventory available for sale, where in the processor is configured implement the steps of:
a. accessing at least one inventory item to be priced, wherein the price of the inventory item is to be accessible to users of an electronic inventory platform;
b. generating a filtering protocol using one or more pre-set pricing criteria,
c. storing the filtering protocol in a database;
d. retrieving a plurality of comparable inventory items from an inventory exchange server wherein the listing of comparable inventory retrieved includes a plurality of data parameters associated with each listing and wherein at least one of the associated data parameters of each listing corresponds to the present price that the inventory item is offered for sale;
e. filtering the plurality of comparable inventory items using the filtering protocol to generate a filtered dataset;
f. determining an aggregate market price based on the respective prices of the items in the filtered dataset;
g. generating a price for the at least one inventory item based on the determined aggregate market price; and
h. updating the electronic inventory platform to reflect the generated price for the at least one inventory item.

13. The method of claim 12, wherein the filtering protocol includes a threshold value corresponding to the minimum number of item entries and the processor is further configured to implement a first of the at least two filtering functions and compare the number of items remaining in the filtered dataset to the threshold value and only implement a subsequent filtering function where the number of items remaining in the filtered dataset exceeds the threshold.

14. The method of claim 12, wherein the filtering protocol is generated by receiving a selection of a least two filtering functions from a user remote from the processor.

15. The method of claim 14, wherein the processor is further configured to provide a plurality of references to pre-set filter functions to a remote user device, where the remote user device is configured to provide visual representations of the references to the pre-set filter functions on a display device.

16. The method of claim 15, wherein the processor is further configured to receive at least one filtering protocol wherein the filtering selection represents a combination of at least two of the pre-set filter function sent to a remote user device.

17. The method of claim 12, wherein at least one filtering protocol includes causing the processor to filter the listing of comparable inventory based on at least one non-price-based parameter.

18. The method of claim 1, wherein the list of comparable inventory is limited to only inventory items that are non-identical to the at least one inventory item.
